(19) United States
(12) Patent Application Publication
(10) Pub. No.: US 2010/0269089 A1
(43) Pub. Date: Oct. 21, 2010

(54) METHOD AND SYSTEM FOR GENERATION OF REUSABLE DESIGN PATTERNS

(76) Inventors: VINOD R PANICKER, Kochi (IN); Anandakumar K., Tirunelveli (IN)

Correspondence Address: GLOBAL IP SERVICES, PLLC, 10 CRESTWOOD LANE, NASHUA, NH, 03062, US

(21) Appl. No.: 12/426,968

(22) Filed: Apr. 21, 2009

(51) Int. Cl. G06F 9/44

(52) U.S. Cl. 717/105

(57) ABSTRACT

A method, system, and apparatus for generation of reusable design patterns are disclosed. In one embodiment, a method for generating a design pattern using a graphics editor includes generating a graphical diagram on a display of a computer based on a graphical element. The method also includes converting the graphical diagram into an additional design pattern in the computer in response to an export command directed to the graphical diagram. Further, the additional design pattern is stored in an XML file format in a designated location. The method further includes reusing the additional design pattern for another graphical diagram generated on the display when the additional design pattern is added to said another graphical diagram.

### FIELD OF TECHNOLOGY

Embodiments of the present invention relate to the field of computer software. More particularly, embodiments of the present invention relate to a software designing tool.

### BACKGROUND

A design pattern is a general solution to a commonly occurring problem in software design. It is a description or template for how to solve a problem that can be used in many different situations. Object-oriented design patterns may show relationships and interactions between classes or objects without specifying the final application classes or objects that are involved. They are documented in a format that does not require specifics tied to a particular problem. In addition, design patterns allow software developers to communicate using well-known notations for software interactions.

Design patterns may be utilized using a graphics editor. A user may select one or more of design patterns available in the graphics editor for a class diagram, where a class diagram in Unified Modeling Language (ULM) is a type of static structure diagram that describes the structure of a system by showing the system's classes, their attributes, and the relationships between the classes. However, the design patterns available in the graphics editor may be limited in numbers, and it may not be so convenient to add new design patterns to the list of design patterns for the graphics editor. In many cases, new design patterns are implemented to the graphics editor by coding the new design patterns using a programming language, which may require programming expertise and development efforts.

### SUMMARY

A method, system, and apparatus for generation of reusable design patterns are disclosed. In one aspect, a method for generating a design pattern using a graphics editor includes generating a first class diagram on a display of a computing device based on at least one first class element, wherein the graphics editor comprises a plurality of design patterns importable to the first class diagram. The method also includes converting the first class diagram into an additional design pattern in the computing device in response to an export command directed to the first class diagram. The method further includes displaying the additional design pattern in a second class diagram generated on the display when the additional design pattern is added to the second class diagram.

In another aspect, an apparatus for generating a design pattern using a graphics editor includes a processor and a memory for temporarily storing a set of instructions, when executed by the processor, causes the processor to perform the method described above.

The methods, systems, and apparatuses disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates an exemplary computing device operable for practicing various embodiments of the present invention;

FIG. 2A illustrates an exemplary network environment operable for practicing various embodiments of the present invention;

FIG. 2B illustrates an exemplary handheld device working in an exemplary network environment, according to one embodiment;

FIG. 3A through FIG. 3D illustrate an exemplary process for generating a first class diagram based on one or more first class elements, according to one embodiment;

FIG. 4A through FIG. 4D illustrate an exemplary process for converting the first class diagram of FIG. 3A through FIG. 3D into an additional design pattern, according to one embodiment;

FIG. 5A through FIG. 5C illustrate an exemplary process for displaying the additional design pattern in a second class diagram created when the additional design pattern is added to the second class diagram, according to one embodiment; and

FIG. 6 illustrates a process flow chart of an exemplary method for reusing an additional design pattern in generating a graphical diagram, according to one embodiment.

The drawings described herein are for illustration purposes only and are not intended to limit the scope of the present disclosure in any way.

### DETAILED DESCRIPTION

A method, system, and apparatus for generation of reusable design patterns are disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

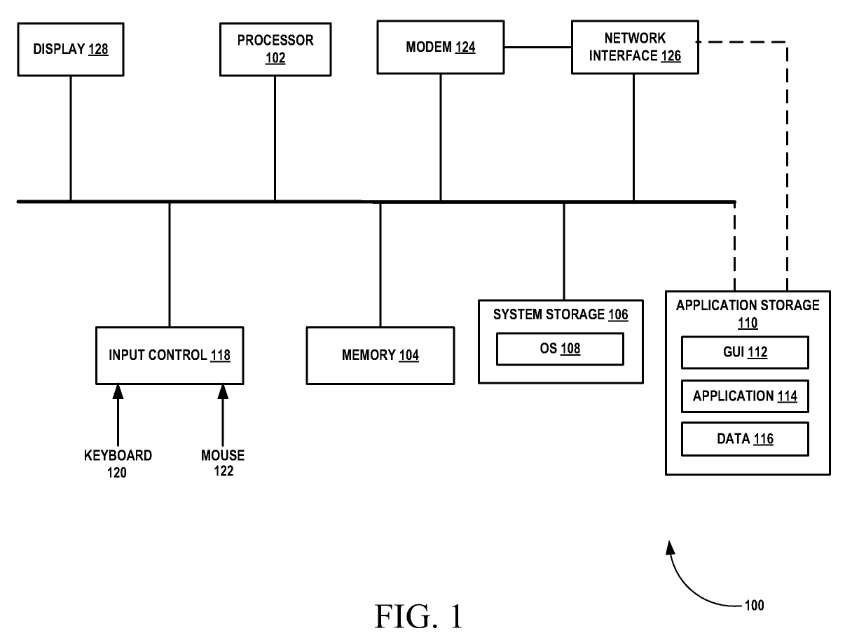

FIG. 1 illustrates an exemplary computing device 100 operable for practicing various embodiments of the present invention. One of ordinary skill in the art will appreciate that the computing device 100 is intended to be illustrative and not limiting of the present invention. The computing device 100 may take many forms, including but not limited to a workstation, server, network computer, quantum computer, optical computer, bio-computer, Internet appliance, mobile device, pager, tablet computer, and the like.

The computing device 100 may be an electronic device and includes a processor 102, a memory 104, a system storage 106 storing an operating system 108, an application storage 110 storing a graphical user interface (GUI) 112, an application 114, data 116, an input control 118 for a keyboard 120 and a mouse 122, a modem 124, a network interface 126, a display 128, etc. The processor 102 controls each component of the computing device 100 for generating reusable design patterns used in a software designing tool. The memory 104 temporarily stores instructions and data and provides the stored instructions and data to the processor 102 so that the processor 102 operates the computing device 100 to generate the reusable design patterns.

The system storage 106 includes code for the OS 108 of the computing device 100. The application storage 110 includes code for the application 114 running on the OS 108 which generates the reusable design patterns as well as the data 116 associated with the reusable design patterns. In one example implementation, the system storage 106 and the application storage 110 may be implemented using a single storage. In another example implementation, the GUI 112, the application 114, and the data 116 may be stored in different storage devices.

The input control 118 may interface with the keyboard 120, the mouse 122, and other input devices. The computing device 100 may receive, through the input control 118, input data (e.g., class element, object element, etc.) necessary for creating the reusable design patterns. The computing device 100 may display user interfaces in the display 128 for users to create, edit and reuse the reusable design patterns. Moreover, the application storage 110 may interface with the computing device 100 directly with the bus of the computing device 100 or via the network interface 126.

In one embodiment, the computing device 100 or an apparatus for generating a design pattern using a graphics editor includes the processor 102 and the memory 104 for temporarily storing a set of instructions. The set of instructions, when executed by the processor 102, causes the processor 102 to perform a method comprising generating a first class diagram on a display of the computing device 100 based on at least one first class element, wherein the graphics editor comprises a plurality of design patterns importable to the first class diagram. The method also comprises converting the first class diagram into an additional design pattern in the computing device 100 in response to an export command directed to the first class diagram. The method further comprises displaying the additional design pattern in a second class diagram generated on the display 128 when the additional design pattern is added to the second class diagram.

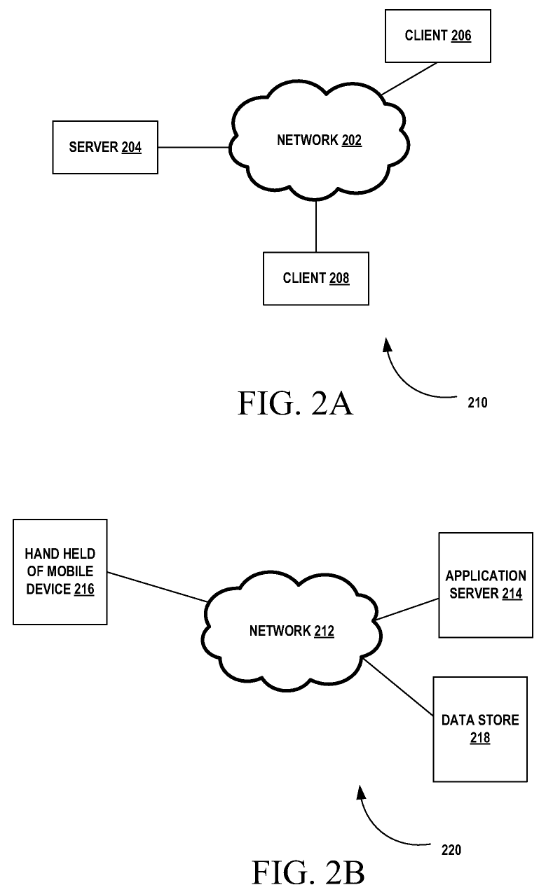

FIG. 2A illustrates an exemplary network environment 210 operable for practicing various embodiments of the present invention. The network environment 210 may include a server 204 coupled to clients 206 and 208 via a network 202 (e.g., a communication network). The server 204 and the clients 206 and 208 can be implemented using the computing device 100 depicted in FIG. 1.

The network interface 126 and the modem 124 of the computing device 100 enable the server 204 to communicate with the clients 206 and 208 through the network 202. The network 202 may include Internet, intranet, LAN (Local Area Network), WAN (Wide Area Network), MAN (Metropolitan Area Network), and/or any other type of wireless or wired communication network. The communication facilities can support the distributed implementations of the present invention.

In the network environment 210 the server 204 may provide the clients 206 and 208 with software components or products under a particular condition, such as a license agreement. The software components or products may include those for generating and reusing the reusable design patterns as illustrated in FIG. 1. The server 204 may send the clients 206 and 208 the software components or products under a specific license agreement.

FIG. 2B illustrates an exemplary handheld device 216 working in an exemplary network environment 220, according to one embodiment. The network environment 220 may include an application server 214 coupled to the handheld device 216 via a network 212. The application server 214 and the handheld device 216 can be implemented using the computing device 100 depicted in FIG. 1.

The network interface 126 and the modem 124 of the computing device 100 enable the application server 214 to communicate with the handheld device 216 through the network 212. In one embodiment of the network environment 220, the handheld device 216 may be configured to run the application 114 independently if the handheld device 216 is equipped with the application storage 110 which includes the GUI 112, the application 114, and the data 116. In another embodiment of the network environment 220, the handheld device 216 may be configured to run the application 114 using the data 116 residing in a data store 218 via the network 212 if the handheld device 216 is equipped with an application storage which includes the GUI 112 and the application 114. In yet another embodiment of the network environment 220, the handheld device 216 may be configured to run the application 114 serviced by the application server 214 using the data 116 stored in the data store 218 via the network 212 if the handheld device 216 is equipped with the GUI 112 only.

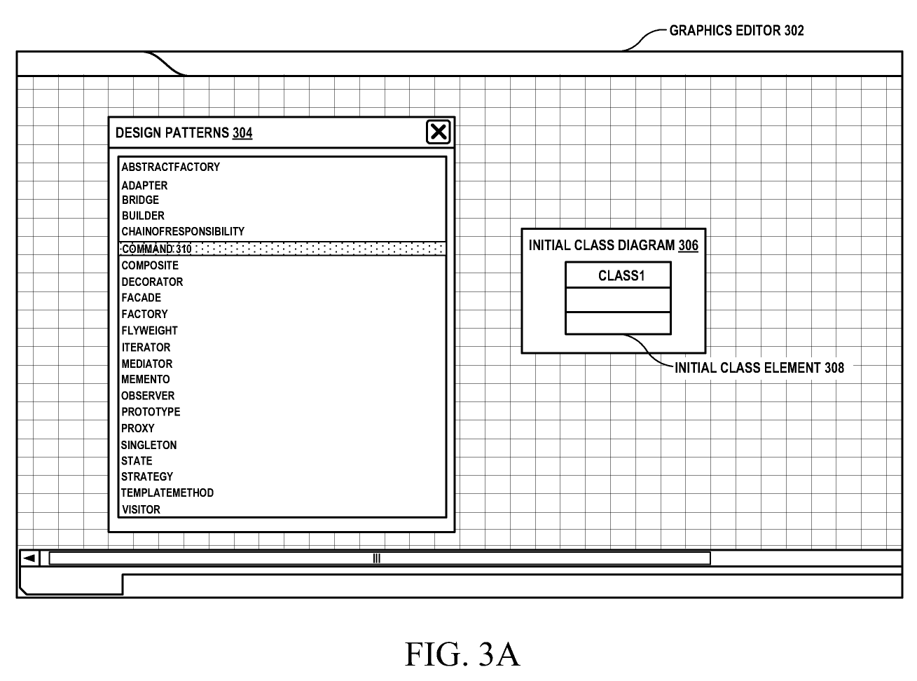

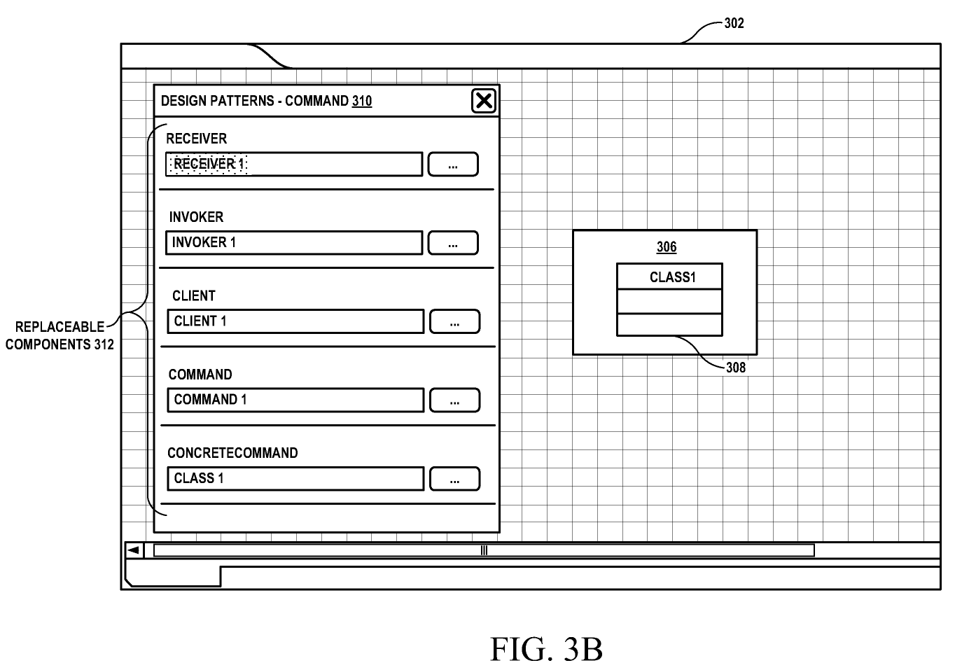

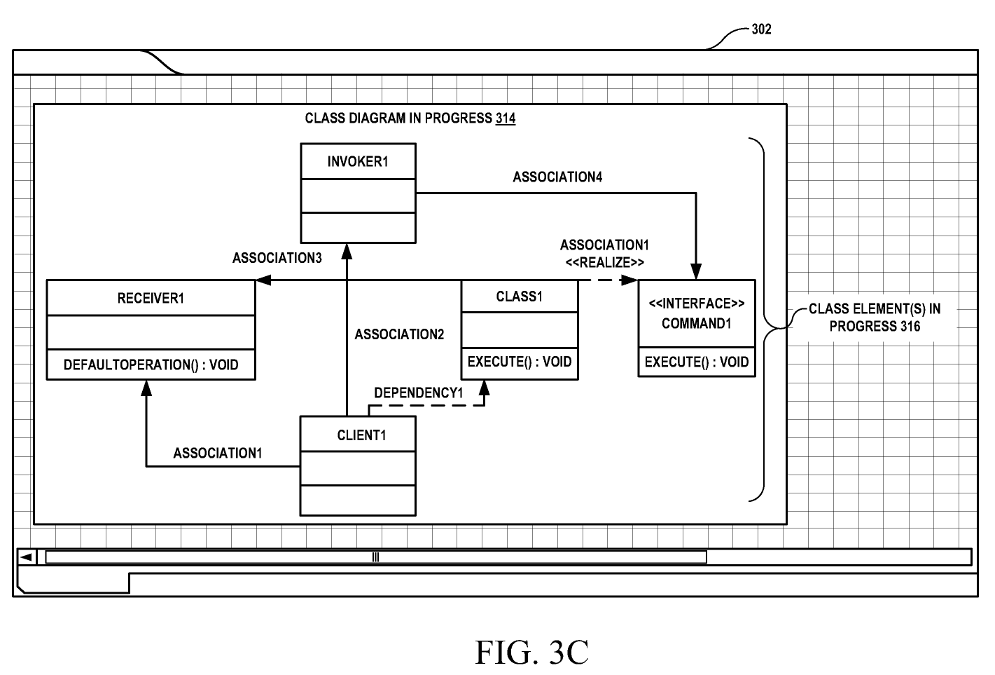

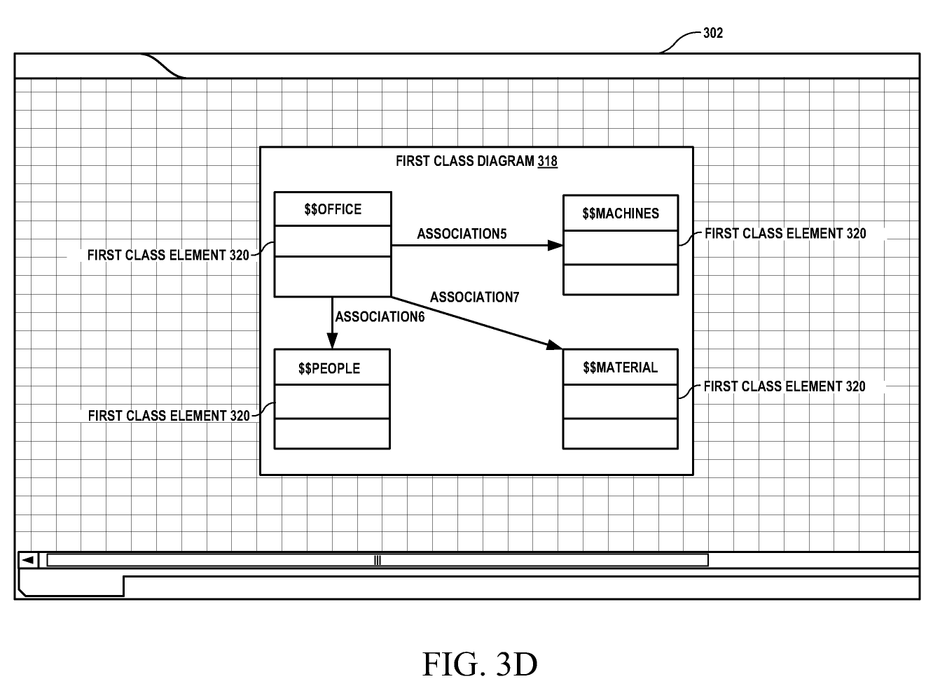

FIG. 3A through FIG. 3D illustrate an exemplary process for generating a first class diagram 318 based on one or more first class elements 320, according to one embodiment. In one embodiment, the first class diagram 318 is generated by creating a new class diagram. In another embodiment, the first class diagram 318 is generated by opening an existing class diagram.

FIG. 3A illustrates a process of generating an initial class diagram 306 based on an initial class element 308 using a graphics editor 302. It can be seen in FIG. 3A that, the graphics editor 302 displays a plurality of design patterns 304. For example, the design patterns 304 include behavioral patterns (e.g., chain of responsibility, command, mediator, memento, observer, state, strategy, template method, visitor, etc.), creational patterns (e.g., abstract factory, builder, factory method, prototype, singleton, etc.), and structural patterns (e.g., adapter, bridge, composite, decorator, facade, flyweight, proxy, etc.). In one embodiment, the design patterns 304 are importable to the initial class diagram 306. In the example embodiment illustrated in FIG. 3A, the initial class diagram 306 is formed by importing a design pattern ‘command 310’ from the design patterns 304 using the graphics editor 302.

Further, FIG. 3B illustrates a process of updating the initial class element 308 using the graphics editor 302. The initial class element 308 includes at least one replaceable component 312 (e.g., receiver, invoker, client, command, concrete command, and the like) associated with the command 310. In one embodiment, the initial class element 308 is created by importing and modifying one of the design patterns 304 (e.g., the command 310). For example, as illustrated in FIG. 3B, the replaceable components 312 associated with the command 310 are updated for creating the initial class diagram 308.

FIG. 3C illustrates a process of transforming the replaceable components 312 to class elements. In FIG. 3C, the graphics editor 302 illustrates a class diagram in progress 314 and a class element(s) in progress 316. As illustrated in FIG. 3C, the class element(s) in progress 316 shows the replaceable components 312 such as receiver 1, invoker 1, client 1, command 1 and class 1. Finally, as illustrated in FIG. 3D, the first class diagram 318 (e.g., office pattern) is generated based on the one or more first class elements 320 (e.g., office, machines, people, material). In one embodiment, the elements in FIG. 3D with “$$” represent replaceable components.

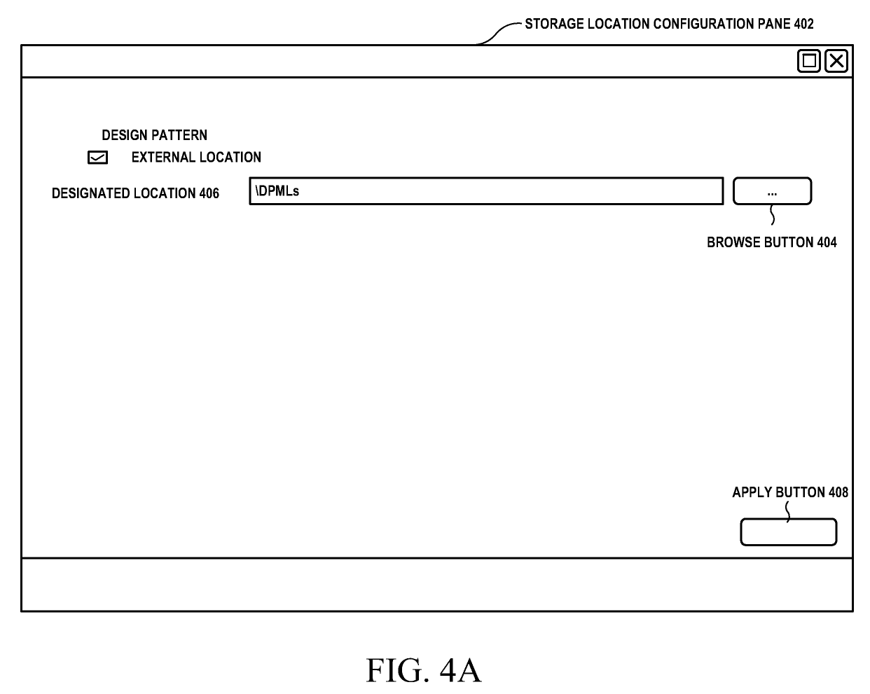

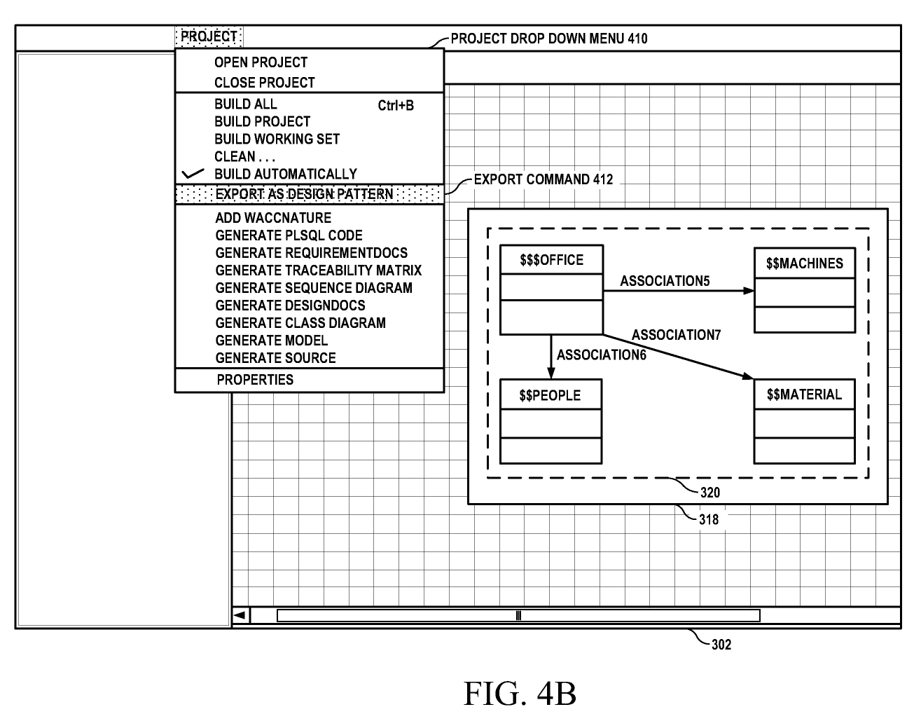

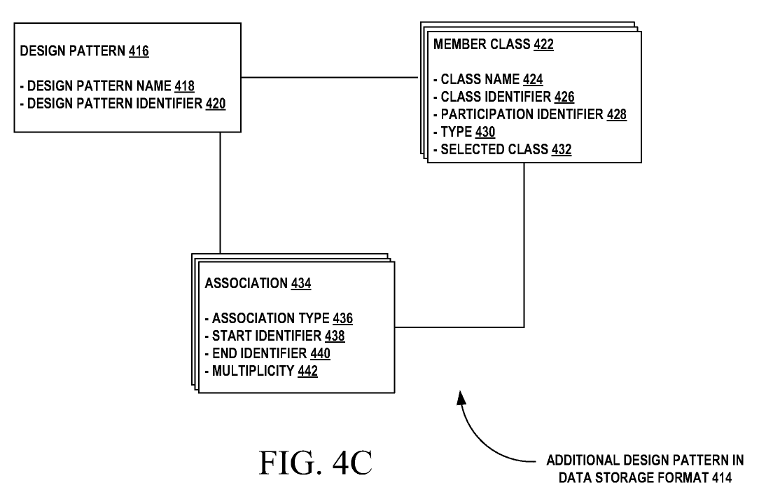

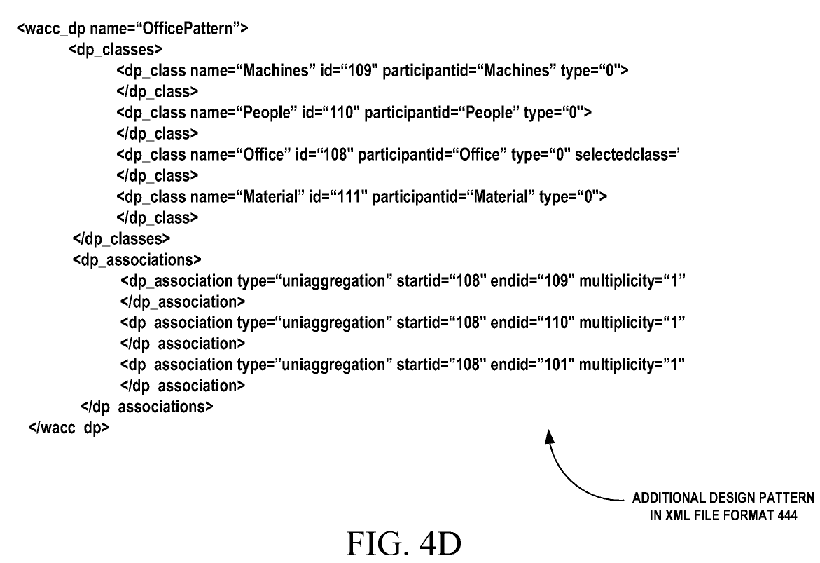

FIG. 4A through FIG. 4D illustrate an exemplary process for converting the first class diagram 318 of FIG. 3A through FIG. 3D into an additional design pattern, according to one embodiment. In one embodiment, the first class diagram 318 is converted into the additional design pattern in response to an export command directed to the first class diagram 318. Further, the additional design pattern is stored in a specified standard format in a designated location 406 (e.g., an external location) for the design patterns 304.

As illustrated in FIG. 4A, a browse button 404 of a storage location configuration pane 402 enables to provide a file path for storing the additional design pattern to the designated location 406 for the design patterns 304. The storage location configuration pane 402 also includes an apply button 408 which enables storing of the additional design pattern to the designated location 406 for the design patterns 304.

Further, FIG. 4B illustrates a process of converting the first class diagram 318 having the first class elements 320 to the additional design pattern (e.g., office pattern) in response to an export command 412 using the graphics editor 302. In the example embodiment illustrated in FIG. 4B, a project drop down menu 410 facilitates selection of the export command 412. Further, in response to the selection of the export command 412, the first class diagram 318 is converted to the additional design pattern ‘office pattern,’ and the additional design pattern ‘office pattern’ is then stored to the designated location 406 in a standard data storage format.

An exemplary additional design pattern in data storage format 414 is illustrated in FIG. 4C. The additional design pattern in data storage format 414 may be a generic data-storage format in terms of relationship between different entities. FIG. 4C illustrates the relationship of a design pattern 416, a member class 422, and an association 434 for the additional design pattern in data storage format 414. In one embodiment, the design pattern 416 includes a design pattern name 418 and a design pattern identifier 420. In one embodiment, the member class 422 includes a class name 424, a class identifier 426, a participation identifier 428, a type 430, and a selected class 432. In one embodiment, the association 434 includes an association type 436, a start identifier 438, an end identifier 440, and a multiplicity 442. An exemplary additional design pattern in XML file format 444 generated using the first class diagram 318 is illustrated in FIG. 4D.

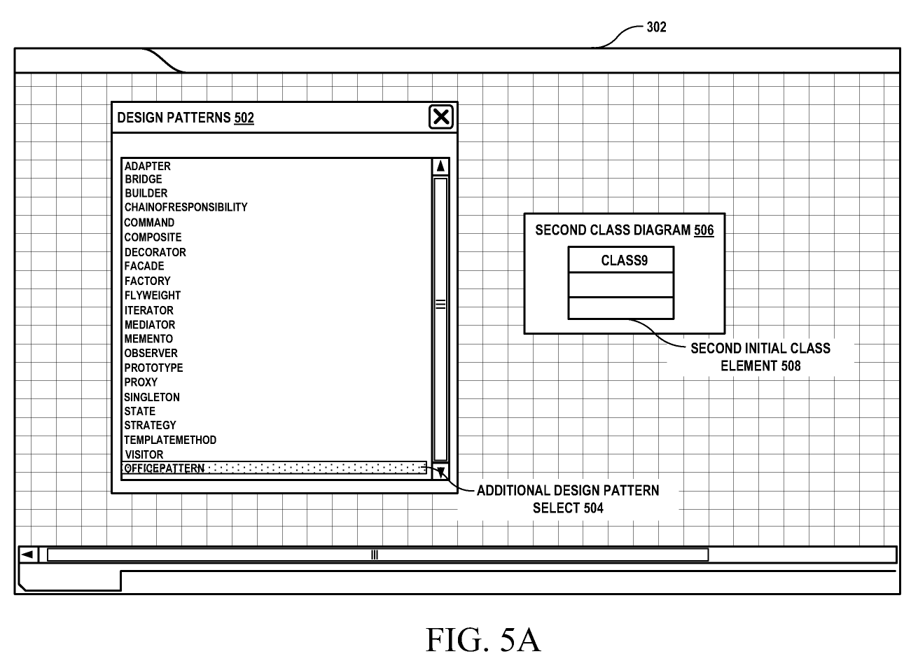

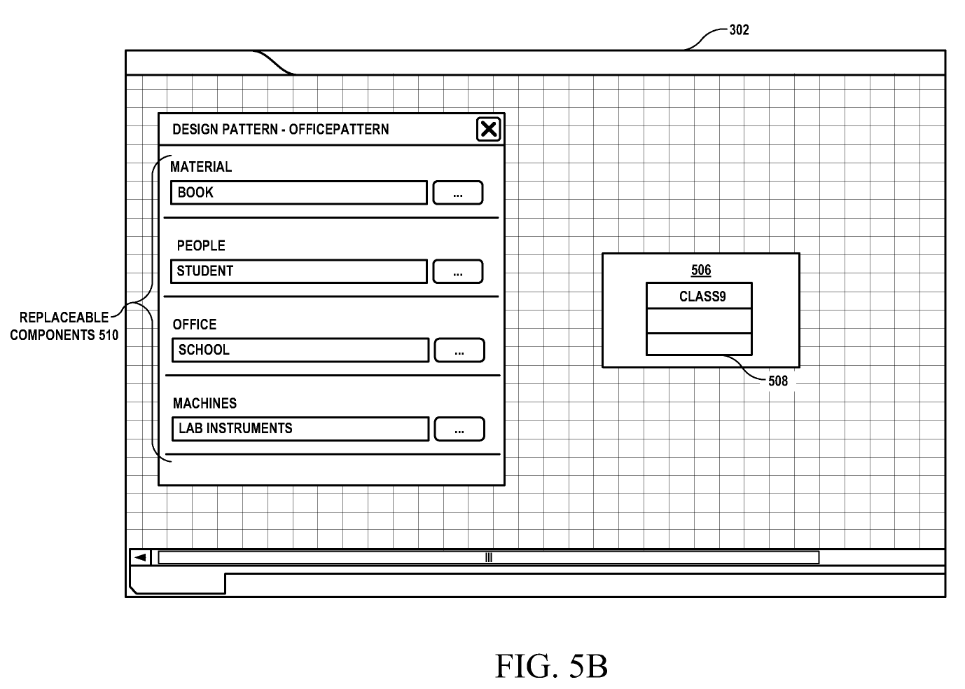

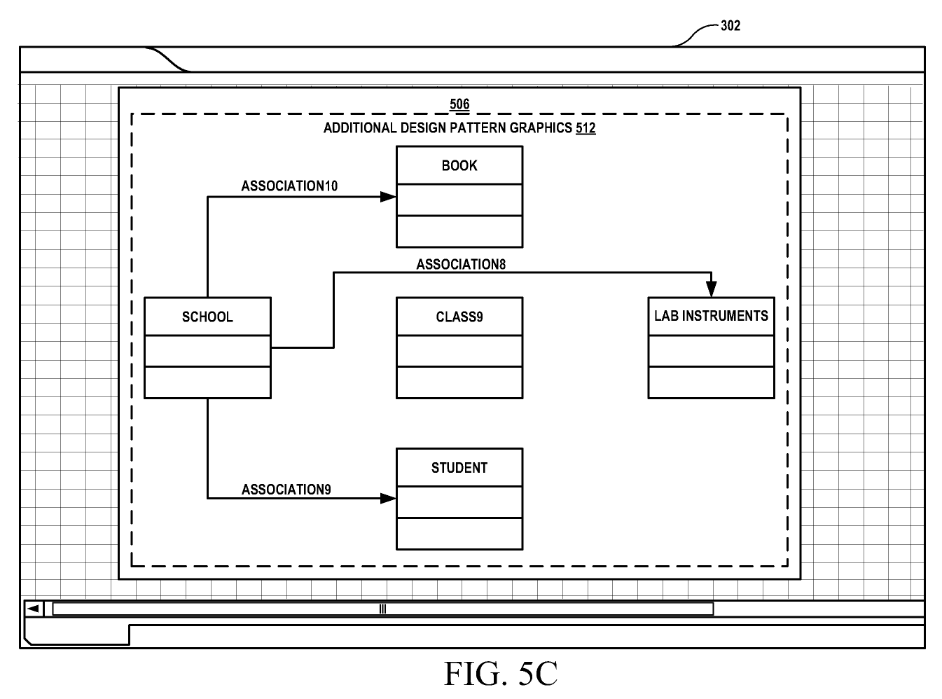

FIG. 5A through FIG. 5C illustrate an exemplary process for displaying the additional design pattern in a second class diagram 506 created when the additional design pattern is added to the second class diagram 506, according to one embodiment. FIG. 5A illustrates the graphics editor 302 showing design patterns 502. It can be noted that, the design patterns 502 includes one or more additional design patterns stored in a specified data store format in the designated location 406. The graphics editor 302 enables selection of one of the design patterns 502 (e.g., ‘office pattern’) using an additional design pattern select 504 for creating the second class diagram 506. In one embodiment, the second class diagram 506 is generated based on a second initial class element 508 using the graphics editor 302.

In the example embodiment illustrated in FIG. 5A, the additional design pattern select 504 is linked to the additional design pattern in XML file format 444 (e.g., the ‘office pattern’) stored in the designated location 406. Further, the ‘office pattern’ is selected by accessing (e.g., clicking) the additional design pattern select 504 to create the second class diagram 506 associated with class systems like ‘school’, post office’, etc.

FIG. 5B illustrates a process of updating replaceable components 510 associated with the office pattern. For example, if the second class diagram 506 is associated with a class system such as school, then the replaceable components 510 (e.g., material, people, office, machines, etc.) associated with the office pattern are replaced with input parameters (e.g., book, student, school, lab instruments, etc.) associated with the school pattern using the graphics editor 302.

Further, as illustrated in FIG. 5C, the graphics editor 302 displays an additional design pattern graphics 512 (e.g., school pattern) in the second class diagram 506 based on the updated replaceable components 510. The second class diagram 506 is created when the additional design pattern (e.g., the office pattern) is added to the second class diagram 506 using the graphics editor 302. In one embodiment, the additional design pattern graphics 512 is displayed in the second class diagram 506 by parsing the additional design pattern ‘office pattern’ in the specified data store format using a design pattern parser. It is appreciated that the design pattern parser may comprise a data reader, a data writer, and a compiler (e.g., Java compiler complier (CC)) for a programming language used to generate the additional design pattern. Thus, in the manner described above, an additional design pattern is first converted and stored in the specified data store format to a designated location for design patterns and then reused for creating another class diagram.

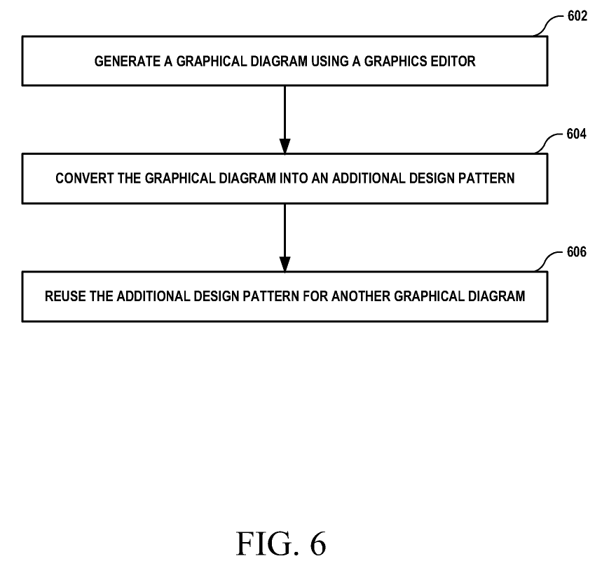

FIG. 6 illustrates a process flow chart of an exemplary method 600 for reusing an additional design pattern to generate a graphical diagram, according to one embodiment. For example, the graphical diagram may be a class diagram or an object diagram. It is appreciated that the class diagram refers to a type of static structure diagram that describes a structure of a system by showing the system's classes, their attributes, and the relationships between the classes. Further, the object diagram refers to a particular set of object instances and attributes, and the links between the instances.

In step 602, a graphical diagram is generated on a display of a computer based on one or more graphical elements (e.g., class elements, object elements, etc.) using a graphics editor. In one embodiment, the graphics editor includes a plurality of design patterns importable to the graphical diagram. In step 604, the graphical diagram is converted into an additional design pattern in the computer in response to an export command directed to the graphical diagram.

Further, the additional design pattern is stored in a specified data store format in a designated location for the plurality of design patterns for the graphics editor. In step 606, the additional design pattern is reused for another graphical diagram when the additional design pattern is added to said another graphical diagram. In one embodiment, the additional design pattern is reused by parsing the additional design pattern in the data store format using a design pattern parser (e.g., based on a Java CC).

Moreover, in one example embodiment, a computer readable medium for generating a design pattern using a graphics editor has instructions that, when executed by a computer, cause the computer to perform the method illustrated in FIG. 6.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present disclosure is not intended to be limited to the embodiments shown herein but is to be accorded the widest scope consistent with the principles and features disclosed herein.

What is claimed is:

1. A method, implemented in a computing device, for generating a design pattern using a graphics editor, comprising:
generating a first class diagram on a display of the computing device based on at least one first class element, wherein the graphics editor comprises a plurality of design patterns importable to the first class diagram;
converting the first class diagram into an additional design pattern in the computing device in response to an export command directed to the first class diagram; and
displaying the additional design pattern in a second class diagram generated on the display when the additional design pattern is added to the second class diagram.

2. The method of claim 1, wherein the plurality of design patterns comprise behavioral patterns, creational patterns, and structural patterns.

3. The method of claim 1, wherein the generating the first class diagram comprises creating a new class diagram.

4. The method of claim 1, wherein the generating the first class diagram comprises opening an existing class diagram.

5. The method of claim 1, wherein the at least one first class element is created by importing and modifying one of the plurality of design patterns.

6. The method of claim 5, wherein at least one first class element comprises at least one replaceable component.

7. The method of claim 1, wherein the converting the first class diagram further comprises storing the additional design pattern in a data store.

8. The method of claim 7, wherein the additional design pattern in the data store is in an XML file format.

9. The method of claim 1, wherein the displaying the additional design pattern comprises parsing the additional design pattern using a design pattern parser.

10. The method of claim 9, wherein the design pattern parser comprises a data reader, a data writer, and a compiler for a programming language used to generate the additional design pattern.

11. The method of claim 1, wherein the computing device comprises a personal computer, laptop computer, a mini computer, a handheld device, and a mobile device.

12. An apparatus for generating a design pattern using a graphics editor, comprising:
a processor; and
a memory for temporarily storing a set of instructions, when executed by the processor, causes the processor to perform a method comprising:
generating a first class diagram on a display of a computing device based on at least one first class element, wherein the graphics editor comprises a plurality of design patterns importable to the first class diagram;
converting the first class diagram into an additional design pattern in the computing device in response to an export command directed to the first class diagram; and
displaying the additional design pattern in a second class diagram generated on the display when the additional design pattern is added to the second class diagram.

13. The apparatus of claim 12, further comprising an application storage for storing an application having the set of instructions.

14. A computer readable medium having instructions that, when executed by a computer, cause the computer to perform a method of generating a design pattern using a graphics editor, comprising:
generating a graphical diagram on a display of the computer based on at least one graphical element, wherein the graphics editor comprises a plurality of design patterns importable to the graphical diagram;
converting the graphical diagram into an additional design pattern in the computer in response to an export command directed to the graphical diagram; and
reusing the additional design pattern for another graphical diagram generated on the display when the additional design pattern is added to said another graphical diagram.

15. The computer readable medium of claim 14, wherein the graphical diagram comprises a class diagram and an object diagram.

16. The computer readable medium of claim 14, wherein the graphical element comprises a class element and an object element.

17. The computer readable medium of claim 14, wherein the converting the graphical diagram further comprises storing the additional design pattern in a data store.

18. The computer readable medium of claim 17, wherein the additional design pattern in the data store is in a standard file format.

19. The computer readable medium of claim 18, wherein the reusing the additional design pattern comprises parsing the additional design pattern using a design pattern parser.

20. The computer readable medium of claim 19, wherein the design pattern parser comprises a data reader, a data writer, and a compiler for a programming language used to generate the additional design pattern.
